(19) United States
(12) Patent Application Publication
(10) Pub. No.: US 2009/0137748 A1
(43) Pub. Date: May 28, 2009

(54) POLYLACTIC ACID-MODIFIED POLYCARBODIIMIDE COMPOUND AND POLYLACTIC ACID RESIN COMPOSITION AND MOLDED ARTICLE COMPRISING THE SAME

(75) Inventors: Shukichi Tanaka, Tokyo (JP); Yukihiro Kiuchi, Tokyo (JP); Masatoshi Iji, Tokyo (JP)

Correspondence Address: YOUNG & THOMPSON, 209 Madison Street, Suite 500, ALEXANDRIA, VA, 22314, US

(73) Assignee: NEC CORPORATION, Tokyo (JP)

(21) Appl. No.: 12/278,644

(22) PCT Filed: Jan. 24, 2007
(86) PCT No.: PCT/JP2007/051077

§ 371 Date: Aug. 7, 2008

(30) Foreign Application Priority Data
Feb. 7, 2006 (JP) 2006-029605

(51) Int. Cl. C08L 67/00

(52) U.S. Cl. 525/418; 525/540

(57) ABSTRACT

The present invention relates to a polylactic acid-modified polycarbodiimide compound which imparts hydrolysis resistance by formulation with a polylactic acid resin and also thereby improves mechanical property. The present invention also relates to a polylactic acid resin composition and a molded article comprising the same.

### TECHNICAL FIELD

The present invention relates to a polylactic acid-modified polycarbodiimide compound and a polylactic acid resin composition and a molded article comprising the same. More specifically, the present invention relates to a polycarbodiimide compound which has been improved in compatibility with a polylactic acid resin by the linkage of polylactic acid. The present invention also relates to a polylactic acid resin composition and a molded article comprising the same which are excellent in hydrolysis resistance and mechanical property.

### BACKGROUND ART

Resins derived from plants have received attention as a substitute for petroleum feedstock in recent years, and resin compositions obtained using various resins kinds derived from plants have been studied actively for their actual use. Particularly, polylactic acid resins have received attention as an example using resins derived from plants and have been being introduced commercially in various applications. The applications of the polylactic acid resins are mainly based on the premise that they are used for a short duration and discarded after use, as with containers and packaging, agricultural films, and the like. Recently, the scope of their applications has been being expanded to consumer durables which require maintaining their initial properties for a long period, such as cabinet materials for household electrical appliances or for OA equipment and automobile parts.

However, polylactic acid resins have the properties of being hydrolyzed more easily than conventional general-purpose resins and therefore have the problem of poor durability. Thus, polylactic acid resins require improving hydrolysis resistance for maintaining their initial physical properties for a long period.

Thus, terminal blockage using compounds having functional groups capable of blocking the carboxylic acid termini of polylactic acid resins, such as carbodiimide compounds or epoxy compounds, has been performed for improving the hydrolysis resistance of polylactic acid resins. In this context, the carbodiimide compound is a compound that has a carbodiimide group [—N═C═N—] in the molecule. This carbodiimide compound is produced by methods for carbodiimide compound production known in the art (e.g., U.S. Pat. No. 2,941,956 (Patent Document 1), Japanese Patent Publication No. 47-33279 (Patent Document 2), J. Org. Chem., 28, 2069-2075 (1963) (Non-Patent Document 1), and Chemical Review, 81 (4), 619-621 (1981) (Non-Patent Document 2)).

It has also been proposed that approximately 1% by mass of a polycarbodiimide compound excellent in heat resistance and stability is added to a polylactic acid resin (Japanese Patent Laid-Open No. 11-80522 (Patent Document 3)). In this polylactic acid resin composition, the carbodiimide group reacts with the carboxylic acid terminus of the polylactic acid resin and blocks this terminus, thereby improving the hydrolysis resistance of the polylactic acid resin.

However, polylactic acid resins, when used in the application of consumer durables, require increasing the amount of a polycarbodiimide compound added to 5 to 10% by mass for sufficiently improving their hydrolysis resistance. As a result, the obtained polylactic acid resin composition presents the problem of deteriorated mechnical property. This is probably because lack of homogeneity in the polylactic acid resin composition increases the polycarbodiimide phase of poor strength dispersed in the composition. Therefore, polylactic acid resins have required further adding a reinforcing agent for improving their mechanical property.

Patent Document 1: U.S. Pat. No. 2,941,956

### Patent Document 2: Japanese Patent Publication No. 47-33279

### Patent Document 3: Japanese Patent Laid-Open No. 11-80522

Non-Patent Document 1: J. Org. Chem., 28, 2069-2075 (1963)

### Non-Patent Document 2: Chemical Review, 81 (4), 619-621 (1981)

### DISCLOSURE OF THE INVENTION

### Problems to be Solved by the Invention

Accordingly, an object of the present invention is to provide a polylactic acid-modified polycarbodiimide compound which imparts hydrolysis resistance to a polylactic acid resin and also contributes to improvement in mechanical property, and to provide a polylactic acid resin composition and a molded article comprising the same.

The present inventors have conducted diligent studies for attaining the object and have consequently found that the problems of related arts can be overcome by improving the compatibility between a polycarbodiimide compound and a polylactic acid resin. Specifically, when a polylactic acid-modified polycarbodiimide compound which comprises a polycarbodiimide compound partially linked to polylactic acid having a particular range of a molecular weight is formulated with a polylactic acid resin, the obtained polylactic acid resin composition maintains high hydrolysis resistance and is largely improved in mechanical property, as compared with the addition of a conventional polycarbodiimide compound. The present invention has been completed based on these findings.

Specifically, the present invention relates to a polylactic acid-modified polycarbodiimide compound which has been improved in compatibility, and a polylactic acid resin composition and a molded article comprising the same, and they are specified by [1] to [5] below.

A polylactic acid-modified polycarbodiimide compound, characterized in that the polylactic acid-modified polycarbodiimide compound is a random copolymer which comprises a structural unit represented by the following general formula (I) and a structural unit represented by the following general formula (II), contains 2 to 10% by mol of the structural unit represented by the general formula (II), and has a number-average molecular weight of 1,000 to 100,000, wherein the structural unit represented by the general formula (II) is linked to a polylactic acid group represented by the following general formula (III):

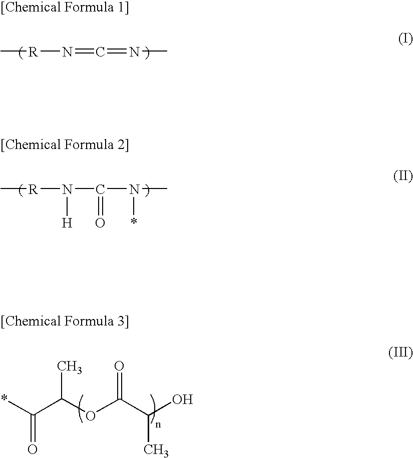

wherein in the formulas (I) and (II), R is a divalent aliphatic, alicyclic, or aromatic hydrocarbon skeleton comprising C and H, the moiety * in the formula (II) is bound with the moiety * in the formula (III), and n is any integer of 6 to 210.

The polylactic acid-modified polycarbodiimide compound according to [1], characterized in that the polylactic acid group represented by the general formula (III) has a number-average molecular weight of 1,000 to 10,000.

The polylactic acid-modified polycarbodiimide compound according to [1] or [2], characterized in that the polylactic acid-modified polycarbodiimide compound has a carbodiimide equivalent of 500 g/eq or less.

A polylactic acid resin composition, characterized by comprising 5 to 20% by mass of a polylactic acid-modified polycarbodiimide compound according to any of [1] to [3] and a polylactic acid resin having a number-average molecular weight of 30,000 or larger as the remainder.

A molded article comprising a polylactic acid resin composition according to [4].

### EFFECTS OF THE INVENTION

The polylactic acid-modified polycarbodiimide compound of the present invention can be improved in a chemical affinity for a polylactic acid resin via the linked polylactic acid group without impairing properties possessed by a conventional polycarbodiimide compound. Moreover, the polylactic acid-modified polycarbodiimide compound of the present invention offers excellent hydrolysis resistance by addition to a polylactic acid resin and also thereby amplifies the entanglement effects of molecular chains, leading to improved mechanical property of a polylactic acid resin composition. Thus, a molded article comprising the polylactic acid resin composition of the present invention is obtained by various methods such as injection molding, film molding, blow molding, and foam molding methods and can be used in various applications such as electrical and electronic equipment (e.g., cabinets for electrical appliances), construction materials, automobile parts, daily necessities, medical uses, and agricultural uses.

### BEST MODE FOR CARRYING OUT THE INVENTION

A polylactic acid-modified polycarbodiimide compound of the present invention is a polycarbodiimide compound characterized in that the polycarbodiimide compound is a polymer which comprises a structural unit represented by the general formula (I) (hereinafter, referred to as a “structural unit I” for the sake of simplification) and a structural unit represented by the general formula (II) (hereinafter, referred to as a “structural unit II” for the sake of simplification), wherein the structural unit II is linked to a polylactic acid group represented by the general formula (III) (hereinafter, referred to as a “polylactic acid group III” for the sake of simplification).

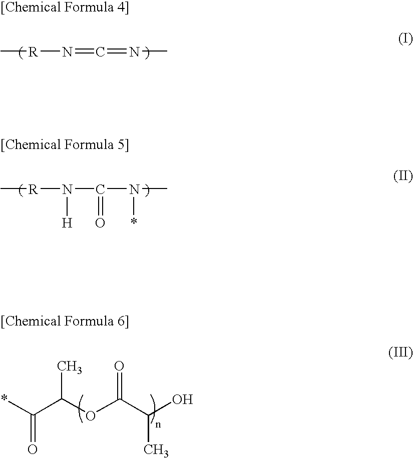

(wherein in the formulas (I) and (II), R is a divalent aliphatic, alicyclic, or aromatic hydrocarbon skeleton comprising C and H, the moiety * in the formula (II) is bound with the moiety * in the formula (III), and n is any integer of 6 to 210.)

Moreover, a polylactic acid resin composition of the present invention is characterized by comprising the polylactic acid-modified polycarbodiimide compound and a polylactic acid resin.

Furthermore, a molded article of the present invention is characterized by comprising the polylactic acid resin composition.

### 1. Polylactic Acid-modified Polycarbodiimide Compound

The polylactic acid-modified polycarbodiimide compound according to the present invention is obtained by grafting polylactic acid to some of plural carbodiimide groups comprising the structural unit I in the molecular chain of the polycarbodiimide compound and thereby forming the structural unit II bound with the polylactic acid group III.

The polycarbodiimide compound can be synthesized by generally well-known methods and used. This polycarbodiimide compound can be synthesized, for example, by subjecting various kinds of organic diisocyanates to decarboxylation condensation reaction at a temperature of approximately 70° C. or higher in the presence or absence of an inactive solvent using an organic phosphorous compound or organic metal compound as a catalyst.

Examples of the organic diisocyanates as a raw material in the production of the polycarbodiimide compound may include aromatic diisocyanate, aliphatic diisocyanate, alicyclic diisocyanate, and mixtures thereof. Specifically, the organic diisocyanates can be exemplified by 1,5-naphthalene diisocyanate, 4,4′-diphenylmethane diisocyanate, 4,4′-diphenyldimethylmethane diisocyanate, 1,3-phenylene diisocyanate, 1,4-phenylene diisocyanate, 2,4-tolylene diisocyanate, 2,6-tolylene diisocyanate, hexamethylene diisocyanate, cyclohexane-1,4-diisocyanate, xylylene diisocyanate, isophorone diisocyanate, dicyclohexylmethane-4,4′-diisocyanate, methylcyclohexane diisocyanate, tetramethylxylylene diisocyanate, 3,3′,5,5′-tetraisopropylbiphenyl-4,4′-diisocyanate, and 1,3,5-triisopropylbenzene-2,4-diisocyanate.

When the polylactic acid-modified polycarbodiimide compound of the present invention is formulated with a polylactic acid resin, the carbodiimide component functions, at the initial stage after addition, to react with the carboxyl group remaining in the polylactic acid resin, which probably promotes hydrolysis, and suppress hydrolysis. This carbodiimide component is then added to the carboxyl group terminus of the polylactic acid resin formed by the cleavage of an ester bond attributed to hydrolysis reaction and thereby works to recombine the molecular chains of the polylactic acid.

The polylactic acid that is bound with the carbodiimide component and fall the polylactic acid group III may be synthesized by generally well-known methods and used. These known methods are a one-step direct polymerization method which comprises directly subjecting L-lactic acid, D-lactic acid, or DL-lactic acid (racemic body) to dehydration condensation in a solvent, and a two-step lactide method which comprises obtaining a cyclic dimer lactide using lactic acid as a raw material and subjecting this lactide to ring-opening polymerization.

Catalysts that can be used in these production methods can be exemplified by metal compounds including tin, antimony, zinc, titanium, iron, aluminum or the like. Among them, tin- or aluminum-based catalysts are preferable, and particularly, tin octylate and aluminum acetylacetonate are preferable.

In the present invention, the polylactic acid used in the production of the polylactic acid-modified polycarbodiimide compound may be obtained by any production method and used. It is preferred that this polylactic acid should have a number-average molecular weight Mn between 500 and 15,000 inclusive, preferably between 1,000 and 10,000 inclusive. When the number-average molecular weight of the polylactic acid falls within this range, the obtained polylactic acid-modified polycarbodiimide compound can produce, by formulation with a polylactic acid resin, a polylactic acid resin composition that achieves hydrolysis resistance and mechanical property at more excellent levels. In this context, the number-average molecular weight Mn of the polylactic acid is associated with a polymerization degree n by the following calculation formula (1):

Mn=72×(n+1) Formula (1).

The grafting reaction of the polylactic acid to the carbodiimide group proceeds through the addition reaction of the carboxyl group in the polylactic acid with the carbodiimide group in the structural unit I. This structural unit I is converted into the structural unit II by the addition of the polylactic acid. This reaction does not involve removing redundant by-products from the system. Therefore, for example, the polycarbodiimide compound and the polylactic acid can be melt-mixed in a solvent such as chloroform and tetrahydrofuran and subjected to reflux to almost quantitatively obtain the polylactic acid-modified polycarbodiimide compound.

Alternatively, this compound may also be obtained by a method comprising melt-mixing the polycarbodiimide compound and the polylactic acid in the absence of a solvent. However, the polylactic acid as a raw material might be decomposed thermally in this method. Thus, the method described above of reaction of these components with a solvent refluxed is more preferable for conducting more precise synthesis.

Of all the carbodiimide groups contained in the polycarbodiimide compound, a proportion linked to the substituent III is designated as a grafting rate X [% by mol]. The grafting reaction almost quantitatively proceeds. Thus, the grafting rate X is determined according to the following calculation formula (2):

X={(a/Mn)/(1/c)}×100=(ac/Mn)×100 Formula (2),

wherein a represents the amount (g) of the polylactic acid per g of the polycarbodiimide compound, Mn represents the number-average molecular weight of the polylactic acid, and c represents the carbodiimide equivalent (g/eq) of the polycarbodiimide compound; i.e., a/Mn refers to the amount by mol of the terminal carboxyl group in the polylactic acid, and 1/c refers to the number of moles of the carbodiimide group per g of the polycarbodiimide compound.

This grafting rate X largely influences the properties of the polylactic acid-modified polycarbodiimide compound. Specifically, too small a grafting rate does not improve compatibility with a polylactic acid resin and does not improve mechanical property. Alternatively, too large a grafting rate reduces the effect of improving hydrolysis resistance. Thus, this grafting rate X is preferably between 2% by mol and 10% by mol inclusive. When the grafting rate X falls within this range, a polylactic acid resin composition formulated the polylactic acid-modified polycarbodiimide compound with a polylactic acid resin has hydrolysis resistance and mechanical property at more excellent levels.

Furthermore, hydrolysis resistance can be improved further by blocking the hydroxyl group terminus of the polylactic acid group III. The blockage of the hydroxyl group terminus is carried out by introducing the polylactic acid group III into the polycarbodiimide compound and then adding a hydroxyl group-reactive compound such as an isocyanate compound into the reaction system.

### 2. Polylactic Acid Resin

The polylactic acid resin in the present invention can be synthesized by generally well-known methods and used, as with the polylactic acid used in the production of the polylactic acid-modified polycarbodiimide compound. These methods are the same as the methods for polylactic acid production. In the present invention, a higher number-average molecular weight Mn of the polylactic acid resin is more preferable. The number-average molecular weight is usually preferably 30,000 or higher, more preferably 70,000 to 100,000.

### 3. Other Additives

The polylactic acid resin composition of the present invention comprises the polylactic acid-modified polycarbodiimide compound and may additionally contain additives other than the polycarbodiimide compound without impairing the effects of the present invention. Examples of such additives may include inorganic fillers, reinforcing agents, coloring agents (titanium oxide, etc.), stabilizers (radical scavengers, antioxidants, etc.), flame retardants (metal hydrates known in the art, halogen-based frame retardants, phosphorus-based frame retardants, etc.), crystal nucleating agents (talc, etc.) known in the art, and antimicrobial, antifungal agents and the like.

Silica, alumina, sand, clay, slag, and the like may be used as inorganic fillers. Needle-like inorganic matters and the like may be used as reinforcing agents. Moreover, the antimicrobial agents may be exemplified by silver ions, copper ions, and zeolite containing these ions.

The polylactic acid resin composition of the present invention can be processed by, for example, injection molding, film molding, blow molding, and foam molding methods, into molded articles used in applications such as electrical and electronic equipment (e.g., cabinets for electrical appliances), construction materials, automobile parts, daily necessities, medical uses, and agricultural uses.

Methods for mixing various kinds of components formulated into the polylactic acid resin composition are not particularly limited. Examples thereof include mixing using a mixer known in the art, for example, a tumbler, ribbon blender, or single- or twin-screw kneader, and melt mixing using an extruder, roll, or the like.

Methods for molding the polylactic acid resin composition of the present invention are not particularly limited. Molding methods required for the production of usual electrical and electronic equipment or products, such as injection molding, injection/compression molding, and compression molding, can be used. The temperature of these melt mixing or molding procedures can be set to the melting temperature or higher of the polylactic acid resin and within a range that does not cause the thermal degradation of the polylactic acid-modified polycarbodiimide compound or the polylactic acid resin.

### EXAMPLES

Hereinafter, the present invention will be described in more detail with reference to specific examples. Physical properties described in Examples were measured and evaluated by methods below.

### (1) Hydrolysis Resistance

A pellet of a produced resin composition was left for a given length of time in an atmosphere involving a temperature of 80° C. and a humidity of 95 RH %. Changes in number-average molecular weight were measured using GPC (gel permeation chromatography). Hydrolysis resistance was evaluated according to the following criteria:

◯ (good): the initial number-average molecular weight was maintained even after a lapse of 150 hours.
x (poor): decomposition proceeded after a lapse of 150 hours, and the initial number-average molecular weight could not be maintained.

### (2) Compatibility

A pellet of a produced resin composition was placed on a slide glass heated to 200° C. After being dissolved, the resin was covered with a cover glass and then cooled to room temperature to prepare a sample for measurement. Subsequently, the sample for measurement was observed with a light microscope to measure the dispersed particle size of the polylactic acid-modified polycarbodiimide compound. Compatibility was evaluated using the results according to the following criteria:

◯ (good): the dispersed particle size of the polylactic acid-modified polycarbodiimide compound was less than 1 μm.
x (poor): the dispersed particle size of the polylactic acid-modified polycarbodiimide compound was not less than 1 μm.

### (3) Mechanical Property (Flexural Property)

A test piece according to JIS K 7171 was prepared from a produced resin composition. The flexural property of this test piece was measured and used as an index for mechanical property.

### Production Example 1

### Production 1 of Polylactic Acid Used for Polylactic Acid-modified Polycarbodiimide Production; Raw Material: Lactic Acid

L-lactic acid (first class grade chemicals) was placed in a flask equipped with a stirring motor and a cooling tube and subjected to dehydration reaction under reduced pressure at 150° C. for 6 hours, with generated water discharged from the system. The obtained reaction mass was precipitated with hexane to obtain polylactic acid (oligomer) having a number-average molecular weight of 300 to 500. In this context, the number-average molecular weight was determined by the quantification of terminal carboxylic acid.

### Production Example 2

### Production 2 of Polylactic Acid Used for Polylactic Acid-modified Polycarbodiimide Production; Raw Material: Lactide

L-lactide (first class grade chemicals) and 150 ppm tin octylate (for the L-lactide) were added to a flask equipped with a stirring motor and a cooling tube and subjected to polymerization reaction at 190° C. in a nitrogen atmosphere. The reaction time was adjusted to obtain polylactic acids differing in molecular weight. Their number-average molecular weights determined by the quantification of terminal carboxylic acid fell within the range of 1,000 to 20,000.

### Production Example 3

### Synthesis of Polylactic Acid-modified Polycarbodiimide Compound (A-1)

100 parts by mass of an aliphatic polycarbodiimide compound “CARBODILITE LA-1” (trade name, manufactured by Nisshinbo Industries, Inc.; carbodiimide equivalent=250 g/eq), 12 parts by mass of the polylactic acid having a number-average molecular weight of 300 (obtained in Production Example 1), and 1000 parts by mass of chloroform were added to a flask equipped with a stirring motor and a cooling tube and subjected to reflux at 65° C. for 6 hours. Then, the solution was reprecipitated with methanol to obtain a polylactic acid-modified polycarbodiimide compound (A-1). The obtained polylactic acid-modified polycarbodiimide compound had a carbodiimide equivalent of 310 g/eq and a polylactic acid grafting rate of 10% by mol.

### Production Examples 4 to 13

### Synthesis of Polylactic Acid-modified Polycarbodiimide Compounds (A-2 to A-9)

Polylactic acid-modified polycarbodiimide compounds (A-2 to A-9) were obtained in the same manner as in Production Example 3 except that the number-average molecular weight of the polylactic acid and the amount of the polylactic acid added were changed as shown in Table 1. Moreover, the obtained polylactic acid-modified polycarbodiimide compounds had a carbodiimide equivalent and a polylactic acid grafting rate shown in Table 1.

TABLE 1
Polylactic acid-modified polycarbodiimide compound

| | Reaction composition | | | | | | |
|---|---|---|---|---|---|---|---|
| | | Polylactic acid | | | | | |
| | LA-1 | as raw material | | | Analysis value | | |
| | Parts | | | Parts | | Carbodiimide | Grafting |
| | by | | | by | | equivalent | rate |
| No. | mass | Mn | n | mass | Mn | g/eq | % by mol |
| A-1 | 100 | 300 | 3 | 12 | 3400 | 310 | 10 |
| A-2 | 100 | 500 | 6 | 20 | 3600 | 330 | 10 |
| A-3 | 100 | 1000 | 13 | 40 | 4200 | 390 | 10 |
| A-4 | 100 | 3000 | 41 | 60 | 4800 | 420 | 5 |
| A-5 | 100 | 7000 | 96 | 60 | 4700 | 410 | 2 |
| A-6 | 100 | 10000 | 138 | 80 | 5400 | 460 | 2 |
| A-7 | 100 | 12000 | 166 | 95 | 5900 | 500 | 2 |
| A-8 | 100 | 20000 | 277 | 160 | 7800 | 660 | 2 |
| A-9 | 100 | 20000 | 277 | 80 | 5400 | 455 | 1 |

Remarks)
LA-1: aliphatic polycarbodiimide compound “CARBODILITE LA-1” (trade name, manufactured by Nisshinbo Industries, Inc.; carbodiimide equivalent = 250 g/eq)

### Example 1

5% by mass of the polylactic acid-modified polycarbodiimide compound (A-4, see Table 1) was mixed with 95% by mass of a polylactic acid resin (manufactured by UNITIKA LTD.; number-average molecular weight: 100,000). This mixture was melt-kneaded in a bench kneader set to adjust the temperature of this mixture to approximately 180° C. to prepare a pellet. The obtained pellet was subjected to the evaluation of hydrolysis resistance and compatibility. Moreover, the pellet dried at 100° C. for 7 hours or longer was used and molded in a compression molder set to adjust a mold surface temperature to 180° C. to prepare a molding having a sheet thickness of 3.2 mm (130 mm in length, 10 mm in width). The mechanical property of the molding was evaluated. The composition and the evaluation results are shown in Table 2.

### Example 2

A pellet was prepared by the same procedures as in Example 1 except that 10% by mass of the polylactic acid-modified polycarbodiimide compound (A-4) and 90% by mass of the polylactic acid resin were used. The pellet was used to evaluate hydrolysis resistance, compatibility, and mechanical property. The composition and the evaluation results are shown in Table 2.

### Example 3

A pellet was prepared by the same procedures as in Example 1 except that 20% by mass of the polylactic acid-modified polycarbodiimide compound (A-4) and 80% by mass of the polylactic acid resin were used. The pellet was used to evaluate hydrolysis resistance, compatibility, and mechanical property. The composition and the evaluation results are shown in Table 2.

### Comparative Example 1

A pellet was prepared by the same procedures as in Example 1 except that only the polylactic acid resin was used. The pellet was used to evaluate hydrolysis resistance, compatibility, and mechanical property. The composition and the evaluation results are shown in Table 2.

### Comparative Examples 2 to 4

Pellets were prepared by the same procedures as in Examples 1 to 3, respectively, except that aliphatic polycarbodiimide “CARBODILITE LA-1” (trade name) was used instead of the polylactic acid-modified polycarbodiimide compound. The pellets were used to evaluate hydrolysis resistance, compatibility, and mechanical property. The composition and the evaluation results are shown in Table 2.

TABLE 2
Polylactic acid resin composition

| | Composition (% by mass) | | | Evaluation results | | |
|---|---|---|---|---|---|---|
| | | | Polylactic | Hydrolysis | | Mechanical |
| | A-4 | LA-1 | acid resin | resistance | Compatibility | property (MPa) |
| Example 1 | 5 | — | 95 | ∘ | ∘ | 121 |
| Example 2 | 10 | — | 90 | ∘ | ∘ | 110 |
| Example 3 | 20 | — | 80 | ∘ | ∘ | 102 |
| Comparative | — | — | 100 | x | — | 100 |
| Example 1 | | | | | | |
| Comparative | — | 5 | 95 | ∘ | x | 100 |
| Example 2 | | | | | | |
| Comparative | — | 10 | 90 | ∘ | x | 87 |
| Example 3 | | | | | | |
| Comparative | — | 20 | 80 | ∘ | x | 75 |
| Example 4 | | | | | | |

Remarks)
A-4: polylactic acid-modified polycarbodiimide compound A-4 (see Table 1)
LA-1: aliphatic polycarbodiimide “CARBODILITE LA-1” (trade name)
Mechanical properties: flexural properties according to JIS K 7171

As is evident from the results shown in Table 2, the formulation of 5 to 20% by mass of the polylactic acid-modified (polylactic acid-grafted) polycarbodiimide compound with a polylactic acid resin achieves high hydrolysis resistance and also improves mechnical property.

### Examples 4 to 8 and Comparative Examples 5 to 7

Pellets were produced by the same procedures as in Example 1 except that polylactic acid-modified polycarbodiimide compounds shown in Table 3 were used. The pellets were used to evaluate hydrolysis resistance, compatibility, and mechnical property. The composition and the evaluation results are shown in Table 3 together with Example 1.

TABLE 3
Polylactic acid resin composition

| | Composition | | | | | | | | |
|---|---|---|---|---|---|---|---|---|---|
| | Polylactic acid-modified polycarbodiimide compound | | | | | Amount of | Evaluation results | | |
| | | Carbodiimide | Polylactic acid group | | | Polylactic | | | Mechanical |
| | | equivalent | Grafting rate | | Amount | acid resin | Hydrolysis | | property |
| | No. | g/eq | % by mol | Mn | % by mass | % by mass | resistance | Compatibility | MPa |
| Example 1 | A-4 | 420 | 5 | 3000 | 5 | 95 | ∘ | ∘ | 127 |
| Example 4 | A-2 | 330 | 10 | 500 | 5 | 95 | ∘ | ∘ | 110 |
| Example 5 | A-3 | 390 | 10 | 1000 | 5 | 95 | ∘ | ∘ | 121 |
| Example 6 | A-5 | 410 | 2 | 7000 | 5 | 95 | ∘ | ∘ | 125 |
| Example 7 | A-6 | 460 | 2 | 10000 | 5 | 95 | ∘ | ∘ | 121 |
| Example 8 | A-7 | 500 | 2 | 12000 | 5 | 95 | ∘ | ∘ | 108 |
| Comparative | A-1 | 310 | 10 | 300 | 5 | 95 | x | x | 85 |
| Example 5 | | | | | | | | | |
| Comparative | A-8 | 660 | 2 | 20000 | 5 | 95 | x | ∘ | 105 |
| Example 6 | | | | | | | | | |
| Comparative | A-9 | 455 | 1 | 20000 | 5 | 95 | ∘ | x | 103 |
| Example 7 | | | | | | | | | |

Remarks)
Polylactic acid-modified polycarbodiimide compound: see Table 1
Mechanical properties: flexural properties according to JIS K 7171

As shown in Table 3, in Examples 1 and 4 to 8, compatibility with a polylactic acid resin is improved, and high hydrolysis resistance is maintained, while mechanical property is improved by 20% or more. In Comparative Example 5, the polylactic acid-modified polycarbodiimide compound has high polarity due to the small number-average molecular weight Mn of the polylactic acid used in grafting, and compatibility with a polylactic acid resin is not improved, while hydrolysis resistance is also deteriorated. In Comparative Example 6, sufficient hydrolysis resistance is not obtained due to the carbodiimide equivalent exceeding 500. In Comparative Example 7, neither compatibility with a polylactic acid resin nor mechanical property is improved due to the small polylactic acid grafting rate.

### INDUSTRIAL APPLICABILITY

A polylactic acid-modified polycarbodiimide compound of the present invention has an improved affinity for a polylactic acid resin and as such, offers excellent hydrolysis resistance and favorable mechnical property by addition to a polylactic acid resin. Thus, a polylactic acid resin composition of the present invention can be molded by various methods such as injection molding, film molding, blow molding, and foam molding methods and can be used in applications such as electrical and electronic equipment (e.g., cabinets for electrical appliances), construction materials, automobile parts, daily necessities, medical uses, and agricultural uses.

1. A polylactic acid-modified polycarbodiimide compound, characterized in that the polylactic acid-modified polycarbodiimide compound is a random copolymer which comprises a structural unit represented by the following general formula (I) and a structural unit represented by the following general formula (II), contains 2 to 10% by mol of the structural unit represented by the general formula (II), and has a number-average molecular weight of 1,000 to 100,000, wherein the structural unit represented by the general formula (II) is linked to a polylactic acid group represented by the following general formula (III): 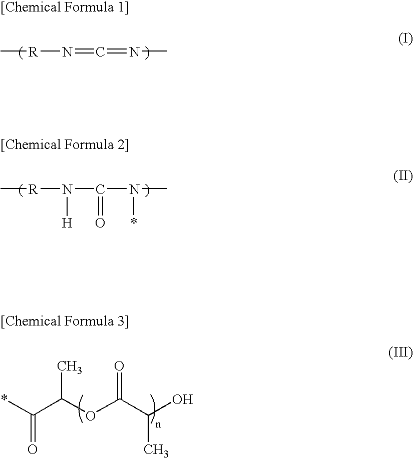
wherein in the formulas (I) and (II), R is a divalent aliphatic, alicyclic, or aromatic hydrocarbon skeleton comprising C and H, the moiety * in the formula (II) is bound with the moiety * in the formula (III), and n is any integer of 6 to 210.

2. The polylactic acid-modified polycarbodiimide compound according to claim 1, characterized in that the polylactic acid group represented by the general formula (III) has a number-average molecular weight of 1,000 to 10,000.

3. The polylactic acid-modified polycarbodiimide compound according to claim 1, characterized in that the polylactic acid-modified polycarbodiimide compound has a carbodiimide equivalent of 500 g/eq or less.

4. A polylactic acid resin composition, characterized by comprising 5 to 20% by mass of a polylactic acid-modified polycarbodiimide compound according to claim 1 and a polylactic acid resin having a number-average molecular weight of 30,000 or larger as the remainder.

5. A molded article comprising a polylactic acid resin composition according to claim 4.

6. The polylactic acid-modified polycarbodiimide compound according to claim 2, characterized in that the polylactic acid-modified polycarbodiimide compound has a carbodiimide equivalent of 500 g/eq or less.

7. A polylactic acid resin composition, characterized by comprising 5 to 20% by mass of a polylactic acid-modified polycarbodiimide compound according to claim 2 and a polylactic acid resin having a number-average molecular weight of 30,000 or larger as the remainder.

8. A polylactic acid resin composition, characterized by comprising 5 to 20% by mass of a polylactic acid-modified polycarbodiimide compound according to claim 3 and a polylactic acid resin having a number-average molecular weight of 30,000 or larger as the remainder.
